(19) United States
(12) Patent Application Publication
(10) Pub. No.: US 2008/0093310 A1
(43) Pub. Date: Apr. 24, 2008

(54) ANTI-MICROBIAL MEDIA AND METHODS FOR MAKING AND UTILIZING THE SAME

(75) Inventors: Eshan B. Yeh, Unionville, CT (US); Robert A. Governal, Middletown, CT (US); Thomas J. Hamlin, Vernon, CT (US); Hemang Patel, Wallingford, CT (US); Marjorie Bucholz, Meriden, CT (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/946,617

(22) Filed: Nov. 28, 2007

Related U.S. Application Data
(63) Continuation of application No. 11/089,258, filed on Mar. 23, 2005.
(60) Provisional application No. 60/555,766, filed on Mar. 24, 2004.

(51) Int. Cl. B01D 37/00; B01D 39/00

(52) U.S. Cl. 210/767; 210/502.1

(57) ABSTRACT

Provided is separation media comprising: a base mixture having an adsorptive organic component and an inorganic component; an anti-microbial component comprising a quaternary ammonium salt containing an epoxide group; and a covalent bond directly between the quaternary ammonium salt containing an epoxide group and the inorganic component. The covalent bond is, for example, between the epoxide group and a hydroxyl group of the inorganic component. The quaternary ammonium salt containing the epoxide group can be poly(methyldiallylamine epichlorohydrin). Further, the quaternary ammonium salt containing the epoxide group can have the formula according to I: 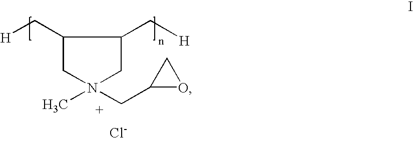 wherein n is in the range of 5 to 24. The inorganic component can be diatomaceous earth, and the adsorptive organic component can be activated carbon.

### CROSS-REFERENCE TO RELATED APPLICATIONS

This application is a continuation of U.S. patent application Ser. No. 11/089,258, filed Mar. 23, 2005, which claims the benefit of priority under 35 U.S.C. § 119(e) to U.S. Appl. Ser. No. 60/555,766, filed Mar. 24, 2004, the disclosures of which are incorporated herein by reference in their entirety.

### TECHNICAL FIELD

The present disclosure relates to fluid filtration media and methods for producing and utilizing fluid filtration media, and more particularly, to fluid filtration media having anti-microbial properties and methods for producing fluid filtration media having anti-microbial properties and employing the same in fluid filtration applications.

### BACKGROUND

Often in both consumer and industrial fluid filtration applications a fluid is filtered prior to its use in an intended application. As a result, fluid filtration systems are installed either internally or externally within the industrial system or consumer appliance.

The EPA Water Purifier Standard requires that a filtration device for drinking water applications remove microorganisms at greater than 6 log for bacteria, 4 log for virus and 3 log for protozoan cysts (“Guide Standard and Protocol for Testing Microbiological water purifiers”, 1987 the disclosure of which is herein incorporated by reference to the extent not inconsistent with the present disclosure).

Microbial contamination can be a problem in water supplies used for human consumption, and for industries that require purified water for production of microelectronics, pharmaceuticals, and biopharmaceutical processes, among others.

There is an on-going need for fluid filtration media and an incorporating device which can effectively meet microbial reduction standards such as those presented by the EPA. In addition, there is a need to immobilize antimicrobial components to minimize leaching.

### SUMMARY

Provided are new and innovative separation media for fluids. One representative separation media for fluids according to the present disclosure comprises a base mixture of organic and inorganic components comprising at least one anti-microbial component; and at least one component of the base mixture comprises a charge-modified group covalently bonded to the surface of the at least one anti-microbial component.

In another representative embodiment, the charge-modified group covalently bonded to at least one component of the base mixture and is selected from the group comprising: charge-carrying monomers, charge-carrying macromolecules, charge-carrying polymers and mixtures thereof, the charge-modified group listed above containing a functional group selected from the group comprising: alkoxy, azeridinium, epoxy, reactive hydrogens, and mixtures thereof.

In yet another representative embodiment, the base mixture is selected from the group comprising: diatomaceous earth, activated carbon, polymers, perlite, porous and non-porous ceramic materials, glass fibers, glass spheres, and combinations thereof.

In still another representative embodiment, the covalently bonded charge-modifying group is permanently associated with at least one component of the base mixture.

In another representative embodiment, separation the anti-microbial component has a positive zeta potential at pH from about 5 to about 9.

In yet another representative embodiment, the molecular mass of charge-carrying monomers, charge-carrying macromolecules, and charge-carrying polymers is less than about 5,000.

In still another representative embodiment, the base mixture includes a polymer of olefin, or polymer having functional groups of —NH₂, —OH, —NH, C═O, —C(═O)—O—, and combinations thereof.

In another representative embodiment, the polymers are selected from the group comprising: cellulose, nylon, polyester, polyurethane, modified polyethylene and polypropylene, and combinations thereof.

In yet another representative embodiment, the charge-carrying monomer comprises: an organo-silane having alkoxy groups and having the following formula:

A₁A₂A₃SiCₚH₂ₚB^{⊕}(CₗH₂ₗ₊₁)(CₘH₂ₘ₊₁)(CₙH₂ₙ₊₁)(CₙH₂ₙ₊₁)X^{⊖}; wherein A₁, A₂, and A₃ are independently CᵣH₂ᵣ₊₁O or OH, where r is in the range of 1 to 5, p is in the range of 1 and 10, B comprises nitrogen or phosphorus, l, m, and n are individually in the range of 1 and 32, and X^{⊖} is an anion, selected from the group comprising: Cl, Br, I, NO₃, OH, ClO₃, SO₃, SO₄, MnO₄, PF₆, or BF₄, and combinations thereof.

In another representative embodiment, the charge-carrying monomer comprises an organo-silane having an alkoxy group according to the following formula:

A₁A₂A₃SiCₚH₂ₚN^{⊕}(C₅H₅)X^{⊖}; wherein A₁, A₂, and A₃ are independently CᵣH₂ᵣ₊₁O or OH, r is in the range of 1 to 5, p is in the range of 1 to 30, N^{⊖}(C₅H₅) is a pyridinium group, and X is Cl, Br, I, NO₃, ClO₃, SO₃, SO₄, MnO₄, PF₆, or BF₄ and combinations thereof.

In another representative embodiment, the at least one charge-carrying macromolecule has branch structure including a plurality of terminals.

In still another representative embodiment, the at least one of the charge carrying macromolecules includes a quaternary ammonium or phosphonium group operatively connected to one or more of the branch terminals.

In yet another representative embodiment, the at least one of the charge carrying macromolecules includes the following repeat unit:

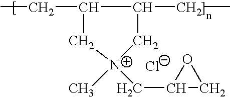

where n is between about 5 and about 24.

In another representative embodiment, the at least one of the charge carrying macromolecules includes the following repeat unit:

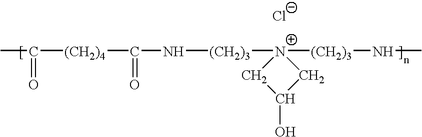

where n is between about 5 and about 16.

In still another representative embodiment, the charge carrying macromolecules include a linking molecule according to the following structure for covalently bonding to at least one component of the base mixture:

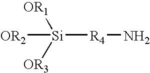

where, R₁, R₂, and R₃ are H's or C₁ to C₅ alkyl groups, R₄ is an aliphatic or aromatic hydrocarbon chain, or the combination of the two, or amino-aliphatic chain, with carbon atoms up to 30.

In yet another representative embodiment, the base inorganic component further comprises: a compound selected from the group comprising: a single transition metal compound or mixtures of transition metal compounds, incorporated therewith by an incipient-wetness impregnation method.

In another representative embodiment, the transition metal compound includes transition metal oxide, halide, and sulfide.

In yet another representative embodiment, the transition metal compound includes: Ag₂O, AgO, Ag₂S and AgCl.

In still another representative embodiment, at least one of the transition metal compounds is dissolved in a solvent having an equal or a lower surface tension than water.

In another representative embodiment, the low surface tension solvent includes organic and inorganic solvents.

In yet another representative embodiment, the low surface tension solvent includes surfactants.

In still another representative embodiment, the transition metal compound is substantially evenly distributed over the surface and in the pores of the inorganic and organic base mixture.

In another representative embodiment, the inorganic base mixture component comprises: silica, alumina, aluminosilicate, magnesia, titania, diatomaceous earth, perlite, and combinations thereof.

In still another representative embodiment, the inorganic base mixture comprises synthetic or naturally occurring inorganic material.

In yet another representative embodiment, the polymeric base mixture comprises: water insoluble polymers.

In another representative embodiment, the base mixture comprises: a composite of two or more components of organic or inorganic nature.

In still another representative embodiment, the base mixture composite includes a polypyrrole coated base mixture wherein in situ polymerization of pyrrole is accomplished by the incipient-wetness impregnation method.

In yet another representative embodiment, the porous and non-porous ceramic material comprises: zeolite.

In another representative embodiment, the transition metal component comprises: an oxide selected from the group comprising: silver, copper, zinc, titanium, zirconium, manganese, tungsten, iron, vanadium, and combinations thereof.

In still another representative embodiment, the organo-silane includes a crosslinked polymer covalently bonded to the surface of the base mixture.

In yet another representative embodiment, the component of the base mixture that has a charge-modified group covalently bonded to the surface of the component has a cationic surface at a pH from about 5 to about 9.

### BRIEF DESCRIPTION OF THE DRAWINGS

FIG. 1 is a schematic illustration of one known process for depositing a metal species on the surface of a solid filter medium substrate;

FIG. 2 is a schematic illustration of a representative process for depositing a relatively thin layer of substantially uniform distribution of a metal species on the surface of a filter medium according to the present disclosure;

FIG. 3 illustrates a representative reaction of three methoxyl groups of octadecylaminodimethyl trimethoxysilylpropyl ammonium chloride with the hydroxyl groups of DE to form a chemical linkage between DE and the antimicrobial octadecylaminodimethyl trimethoxysilylpropyl ammonium chloride;

FIG. 4 illustrates the DE surface after reaction of a representative form of any one a plurality of possible forms that such substituted quaternary silane could take in accordance with the present disclosure;

FIG. 5 illustrates another representative possible form of linkage of a plurality of possible leakage forms between the DE substrate and the charged silane species;

FIG. 6 illustrates another of the plurality of possible representative functional groups that can react with DE, specifically epoxy groups, in accordance with the present disclosure;

FIG. 7 illustrated the use of coupling agents to enhance the reactivity of the groups to the surface of DE, in accordance with the present disclosure;

FIG. 8 is an illustration of representative examples of the surface modification of DE utilizing the coupling agents of FIG. 7; and

FIG. 9 illustrates one representative surface modification of one representative filter media in accordance with the present disclosure.

### DETAILED DESCRIPTION

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

The representative fluid filter medium used in the present disclosure includes, but is not limited to activated carbon (AC), diatomaceous earth (DE), powders of polyethylene, fibers of polyethylene and polypropylene, and a lead adsorption component such as titanium silicate (ATS, Engelhard Corp, Iselin, N.J.). Both AC and DE are active components and are major fluid filtration components, as they allow fluids, such as, for example, water to flow through and mechanically separate and/or adsorb undesired species present in influent fluid, such as, for example, water used for drinking purposes, from being present in the effluent fluid stream by at least one or more of the following mechanisms: mechanical sieving, adsorption and charge interactions.

While the specific examples and details of the present disclosure relates to microbial reduction in water, it is believed that the technical principles and the specific chemical concepts discussed herein will most likely apply to microbial reduction in the gas phase as well. Thus, whenever the term fluid is used in the present disclosure, it is understood to mean fluid in the conventional sense including liquids, such as for example, water and gas, such as for example, air.

Filter Medium Block

As used in the present disclosure, the term “green strength” means the strength a block structure has when the block is compressed without baking. A minimum of such green strength is needed when the block is subjected to human or robotic handling when preparing for the process of baking.

The filter medium block used in the following examples of the present disclosure was made based on U.S. Pat. No. 5,882,517 issued to CUNO, Incorporated, the disclosure of which is herein incorporated by reference, to the extent not inconsistent with the present disclosure. U.S. Pat. No. 5,882,517 describes a porous structure based on activated carbon (hereafter AC) and various powder and fibrous components. The green strength is maintained by a rod-shaped fiber. The remaining components described in U.S. Pat. No. 5,882,517 act as binders. The binders, especially the one that melts during baking, provide the strength after the block is subjected to a pressure of about 2000 psi at room temperature and then baked at a temperature of about 142° C. for about 45 minutes, as described in U.S. Pat. No. 5,882,517. While there are many binders used by those skilled in the art, the presently preferred binder used in this disclosure is micron sized polyethylene powders having a melting point of about 110° C. In the present disclosure, at least part of the AC is replaced with diatomaceous earth (hereafter DE) and the DE is then subjected to modifications in order to provide antimicrobial activities.

Metal Particle Dispersion

One of a plurality of possible modifications to filter mediums to impart anti-microbial activity is to disperse a uniformly thin layer of a transition metal species, (where a transition metal is, presently preferably, defined herein as an element from the ‘B’ group of the periodic table which forms one or more stable ions which have incompletely filled ‘d’ sublevels or orbitals, and does not include lanthanides and actinides) such as, for example, zinc, copper, iron, silver species, on the medium. The process of depositing a metal species on the surface of a solid filter medium substrate is known in the art as “impregnation”. In the present disclosure, the metal species can be impregnated on AC and/or DE. One effective method to impart a metal species, such as, for example, silver is via a silver nitrate solution.

As illustrated in FIG. 1, in one known practice, silver nitrate is dissolved in water to a predetermined concentration and then added to AC or DE to the point of incipient wetness, which is a subjective judgment when the flow of AC or DE powder begins to slow down (as an example a visually detectable resistance to rolling of the media within a jar mill), but before the formation of any appreciable agglomerate. By the term “incipient wetness” is meant the state when a particle of porous or nonporous nature is at least partially, and presently preferably, fully coated with a layer of wetting liquid. For practical purpose, a later stage of incipient wetness, i.e., before the formation of any agglomerate, is preferred.

Since water has a very high surface tension (72.0 dynes/cm at 25° C.), which not only is expected to form localized large silver nitrate particles when water is evaporated, but also hinders the accessibility of water to the smaller areas of the filter medium. Given this process, one possible approach to at least significantly reducing if not substantially eliminating the accessibility problem is to use benign non-aqueous solvents of low surface tension that can dissolve silver salts to solve this wetting and dispersion problems in order to provide both highly dispersed smaller particle size silver species that can evenly distribute over the entire liquid-wetted surface of the filter medium substrate. These preferred solvents include, but are not limited to, low molecular weight alcohols, such as, for example, methanol, ethanol, propanol, isopropanol, and the like having the general structure of CₙH₂ₙ₊₁—O—H with ethanol being presently preferred which has a surface tension of about 22.0 dynes/cm at about 25° C. Other solvents including supercritical fluids (SCF) and surfactants in water or other solvent systems, with a final surface tensions range from about 1 dyne/cm to about 72 dynes/cm at 25° C. shall be included (water, for example has a surface tension of about 72 dynes/cm at 25° C. The solvent system with presently preferred final surface tension of 15 to 50 dynes/cm, including for example trimethylamine (13.4 dynes/cm), diethyl ether (16.7 dynes/cm), 2-methyl-2-propanal (20.0 dynes/cm), all C1 to C6 alcohols in this range for example: 1-hexanol (25.8 dynes/cm), diethylene glycol (44.8 dynes/cm) and the most presently preferred surface tension of 20 to 30 dynes/cm is included in this disclosure.

Using the benign solvents or other similar mechanisms, a thin layer of substantially uniform distribution of silver nitrate particles is formed when the benign solvent, such as, for example, ethanol is evaporated. The above two processes are illustrated by the figures discussed below.

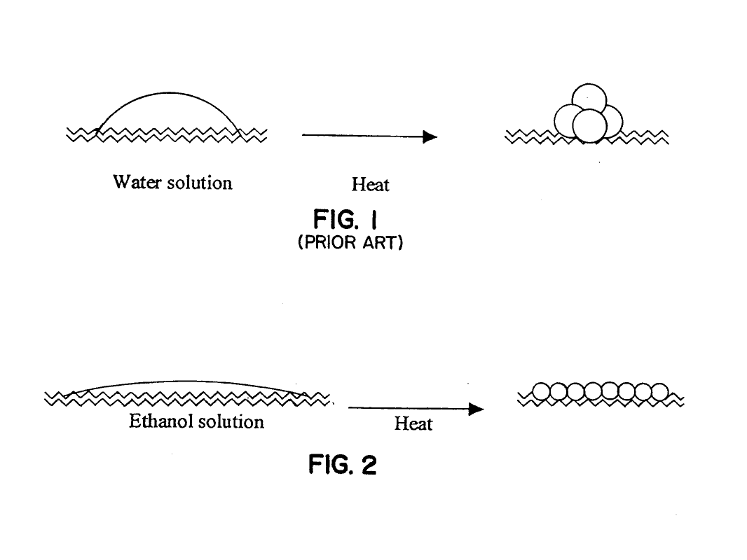

As illustrated in FIG. 2, using a benign solvent having a surface tension of about 20 to about 40 dynes/cm at about 20 to about 25° C., such as, for example, an ethanol solution of silver nitrate, provides at least three benefits: 1) small but uniformly distributed silver nitrate particles provide greater surface area coverage of the filter medium substrate, 2) maximum coverage of the filter medium substrate surface includes, but is not limited to, micro pores where only a relatively low surface tension liquid can penetrate and subsequently wet such micro pores, and 3) small but uniformly distributed silver nitrate particles have a higher adhesion to the filter medium substrate surface, as compared to the water based system. The better adhesion of small particles to the substrate surface will reduce the possibility of particle leach into effluent stream.

Modification of AC and DE Surfaces

As is known by those skilled in the art, AC has a very complicated molecular structure. Due to the thermal treatments during processing, the AC surface has mostly oxygen-containing groups such as —OH, —CO, and —COOH. Since these oxygen-containing groups are positioned on fused rings, their concentrations are believed rather low. This relatively low concentration of these oxygen-containing groups reduces the reactivity of the activated carbon (AC). Highly oxidized surface can be achieved by reacting nitric acid or sulfuric acid, or this highly oxidized surface can be achieved in the presence of ozone or oxygen plasma, UV, or other methods to oxidize the surface. In addition to oxidation, the surface can be treated to provide amine groups for further surface modification. One example of such modification is to react surface amine or surface hydroxyl groups with chemical species that has reactive epoxy or other active groups available for reaction, or can be linked through an agent that has epoxy or other active groups available for reaction, such as alkoxy, azeridinium, reactive hydrogens (hydrogen atoms linked to atoms with greater elecronegativity (>0.4 on the electronegatively scale) than elemental hydrogen, beyond that of a weak polar covalent bond), and mixtures thereof. Unless the concentration of surface amines or hydroxyls is high enough so that the surface modification shows its antimicrobial effect, such modification generally does not give a significant result for this application. As explained above, there may not be enough surface modification on activated carbon. Thus, there is a need to include a second active component in the filtration medium.

DE is a naturally occurring material, composed of skeletal remains of single-celled plants called diatoms. In the diatoms' lifetimes, the diatoms abstract silica and other minerals from water, and when the diatoms die, only the diatoms skeleton shapes remain. Since DE has a mixture of minute particles of different size, shape and structure, it has been used for many years as a filter media or as a filter aid. The composition of un-processed DE is mostly silica, with some alumina, calcium oxide, iron oxide, titania, etc. Despite its compositional complexity, the surface of DE is covered with hydroxyl groups when in a moisturized environment. The present disclosure describes, among other features, the use of such surface hydroxyl groups to react with charged antimicrobial species so as to charge modify the surface to process antimicrobial ability. It is believed that activated carbon, polymers, ceramics, and transition metals once treated, if necessary, to generate surface hydroxyl groups, may also be reacted in this way to generate antimicrobial activity.

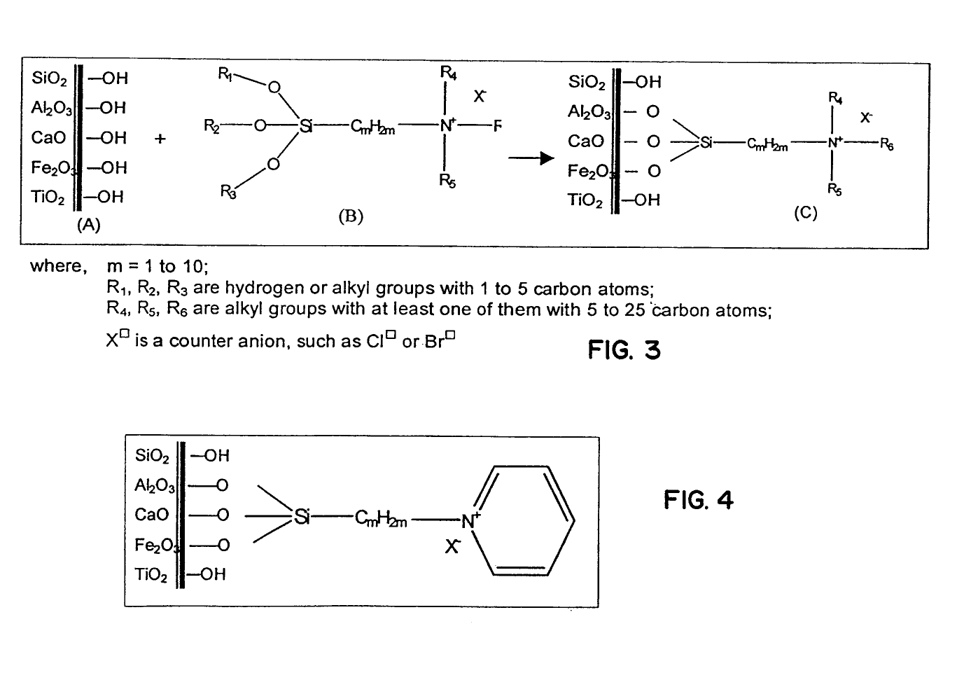

In the early 1970's, a group of organosilicon quaternary ammonium compounds was developed by Dow Corning, and many have been studied with respect to showing antimicrobial properties. Out of those studied, octadecylaminodimethyl trimethoxysilylpropyl ammonium chloride (DC-9-6346) is one of the most cited in the antimicrobial literature (for example, U.S. Pat. No. 3,560,385). The three methoxyl groups of octadecylaminodimethyl trimethoxysilylpropyl ammonium chloride can react with the hydroxyl groups of DE to form a chemical linkage between DE and the antimicrobial octadecylaminodimethyl trimethoxysilylpropyl ammonium chloride. The reaction is generally illustrated in FIG. 3.

As illustrated in FIG. 3, (A) represents DE including the major constituents in DE and the surface hydroxyl groups. (B) represents the generalized form of organosilicon quaternary ammonium compounds. (C) represents the attachment of (B) on the surface of (A) without implying a specific attachment location.

One representative example of such quaternary ammonium salt of a substituted silane is octadecylaminodimethyl trimethoxysilylpropyl ammonium chloride, which is commercially available from Dow Corning Corporation (DC-9-6346) or Aegis Environmental Management Inc. (AEM 5700).

There are many forms that such substituted quaternary silane can take. For example, the quaternary nitrogen atom is in a ring so that, after reaction, the DE surface will have a structure similar to the structure illustrated in FIG. 4.

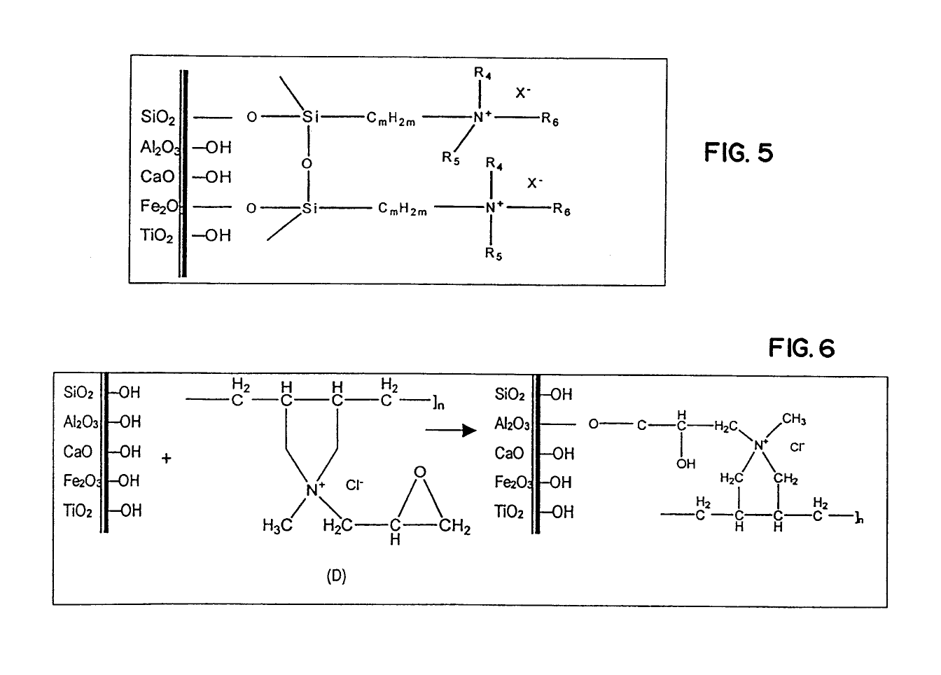

There are other possible forms of linkage between the DE substrate and the charged silane species, such as, but not limited to, the linkage illustrated in FIG. 5 where two adjacent silane groups linked to DE are coupled together via the alkyloxy linkage.

In addition to the reactions of quaternary amine substituted silanes with DE via hydroxyl or alkyloxy groups, there are other functional groups that can react with DE. One representative example of such reaction is via, but not limited to, the epoxy groups as illustrated in FIG. 6. In this embodiment, therefore, provided is a separation media that is free of a coupling agent. One or more embodiments of a separation media comprise a base mixture having an adsorptive organic component and a surface-modified inorganic component. The surface-modified inorganic component can be a reaction product of an anti-microbial component comprising a quaternary ammonium salt containing an epoxide group and an inorganic component, and it can thereby contain a covalent bond directly between a cation of the quaternary ammonium salt and the inorganic component. In one or more embodiments, the covalent bond is the result of a reaction between the epoxide group and a hydroxyl group of the inorganic component.

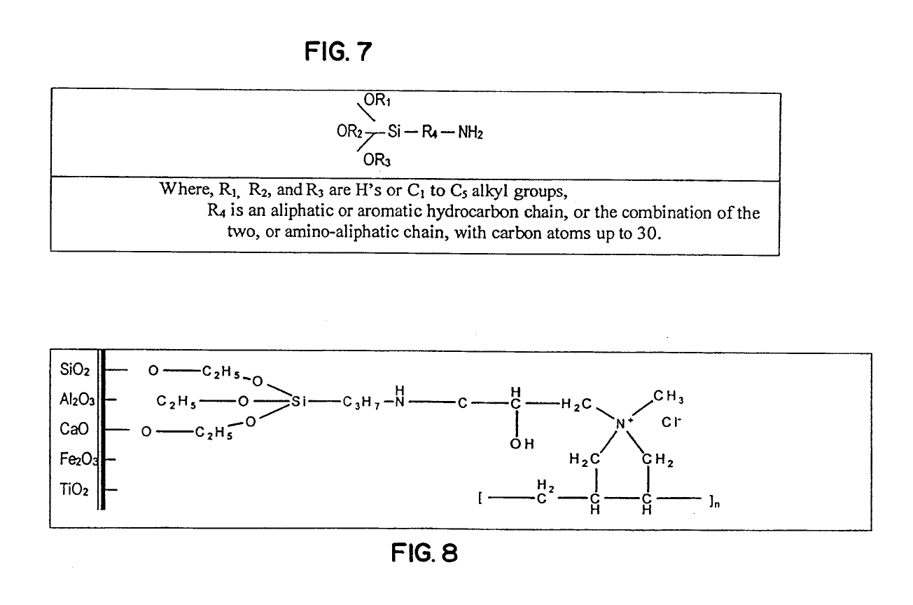

In case the reactivity of such reaction is low, coupling agents can be used to chemically link such epoxy-carrying quaternary ammonium species onto the surface of DE. These coupling agents include, but are not limited to, a coupling agent having a structure similar to that illustrated in FIG. 7.

Representative examples of such surface modification of DE include, but are not limited to, the structure as illustrated in FIG. 8.

Whether these charge-modifying compound are polymers as shown in (D) of FIG. 6, or macromolecules as shown in (B) of FIG. 3 with a large m number, such as greater than about 10, or a monomer such as shown in (D) of FIG. 6, where n is equal to one, they all can absorb small negatively charged species, such as, but not limited to, bacteria and viruses. But not all charge-carrying species described above possess the ability to inactivate the life processes of microbes. It seems that a unique combination of the size and/or the shape of such charge-carrying species will possess such function to inactivate the life processes of microbes. It is particularly interesting to explore the interactions between microbes and a charged compound, where the charged compound has a branched structure with a charged center, such as, but not limited to, quaternary amine at the terminal of each branch.

Antimicrobial Testing

In addition to performing testing in order to closely follow the “Guide Standard and Protocol for Testing Microbiological Water Purifiers” issued by the United States Environmental Protection Agency (US EPA) in 1987, an equivalent low biohazard test method was developed and revealed in this disclosure. Brevundimonas diminuta (ATCC-19146) shall be used as the bacterial surrogate, the bacteriophage MS-2 (ATCC-15597-B1) shall be used as a viral surrogate for poliovirus, and the bacteriophage PRD-1 shall be used as a viral surrogate for rotavirus SA-11.

The methods that are used for suspension preparation, density determination, negative control and analysis of the challenge organisms for use/testing are presented below:

Test Water Requirements:

A treated water that meets the following characteristics was used as the water for both ‘seeded’ testing (microorganisms added to challenge levels) as well as ‘unseeded’ testing (no additional microorganisms):

| Chlorine or other disinfectant residual | Free of any | |
|---|---|---|
| Hardness (as CaCO₃) | Not more than 170 mg/L | |
| pH | 7.5 ± 0.5 | |
| Temperature | 20° C. ± 2.5° C. | |
| Total Organic Carbon (TOC) | 0.5 ± 0.1 | mg/L |
| Total dissolved solids (TDS) | 200-500 | mg/L |
| Turbidity | <1 | NTU |

Any measurable amount of chlorine was removed by sodium thiosulfate, which is a known art in this field. Prior to the seeding treatment, the water shall be pre-filtered with an NSF standard 42 filtration device that has been properly flushed as per the manufacturer's instructions.

Another water supply was used for leaching purposes. The water supply used for leaching purposes was similar to the one described above with the pH being in the range of about 5.0±0.2 pH units and the TDS value less than about 100 mg/L.

Microorganisms

As used in the following examples, all organisms were obtained from: American Type Culture Collection, 19301 Parklawn Drive, Rockville, Md. 20852-1776.

Test Organisms with associated hosts used in the examples are Brevundimonas diminuta (ATCC #19146), MS-2 (ATCC #15597-B1), and E. coli (ATCC #15597, host organism for bacteriophage MS-2).

Bacterial Challenge ‘Seeded’ Test Water

A water supply with the following characteristics was used in the following examples.

| Bacterial challenge level | >100,000,000 (1 × 10⁸) cfu/L | |
|---|---|---|
| Hardness (as CaCO₃) | Not more than 170 mg/L | |
| pH (NaOH adjusted) | 9.0 ± 0.2 | |
| Temperature | 4° C. ± 1° C. | |
| Humic acid (Sigma- Aldrich) as | >10 | mg/L |
| Total Organic Carbon (TOC) | | |
| Sea salt (Sigma-Aldrich) or NaCl | 1500 mg/L ± 150 mg/L | |
| (Reagent Grade) as Total dissolved | | |
| solids (TDS) | | |
| Turbidity (test dust of <5 micron size | >30 | NTU |
| with 20% to 40% (volume) >2.5 micron) | | |

Viral Challenge ‘Seeded’ Test Water

A water supply with the following characteristics was used during the following testing examples.

| Viral challenge level | >10,000,000 (1 x 10⁷) pfu/L | |
|---|---|---|
| Hardness (as CaCO₃) | Not more than 170 mg/L | |
| pH (NaOH adjusted) | 9.0 ± 0.2 | |
| Temperature | 4° C. ± 1° C. | |
| Humic acid (Sigma-Aldrich) as | >10 | mg/L |
| Total Organic Carbon (TOC) | | |
| Sea salt (Sigma-Aldrich) or NaCl | 1500 mg/L ± 150 mg/L | |
| (Reagent Grade) as Total dissolved | | |
| solids (TDS) | | |
| Turbidity (test dust of <5 micron size | >30 | NTU |
| with 20% to 40% (volume) >2.5 micron) | | |

Although a turbidity of greater than about 30 NTU was used for this testing, it is believed that since the test dust is quickly removed on a filtration surface through mechanical reduction, that the internal structure of a filter will be exposed to lower turbidity water. It is believed that the results shown may be obtained irrespective of the concentration of test dust used in the challenge water as specified above.

Buffer Solutions Preparation:

Sterile buffered dilution water (SBDW) was prepared according to the Standard Methods for the Examination of Water and Wastewater (dilution water:buffered water). Two buffer solutions are used and prepared as defined below: Phosphate buffer saline (PBS) with about a pH 7.4, and Trizma (Tris) buffered saline (TBS) with about a pH 7.3.

Phosphate buffer saline (PBS)— a stock solution was prepared by dissolving 80 g sodium chloride (NaCl), 2 g potassium dihydrogen phosphate (KH₂PO₄), 29 g hydrated disodium hydrogen phosphate (Na₂HPO₄.12H₂O) and 2 g potassium chloride (KCl) in water to a final volume of 1 L. A working solution was prepared from the stock solution by diluting 1 volume of the stock with 9 volumes of water. The pH was adjusted using a pH meter to 7.4 with 0.1 N HCl or 0.1 N NaOH before use.

Trizma (Tris) buffered saline (TBS): Sigma-Aldrich Chemical, St. Louis, Mo., USA. A stock solution was prepared by dissolving 2.42 g Tris and 29.24 g NaCl in water to a final volume of 1 L. The pH was adjusted using a pH meter to 7.3 with 0.1 N HCl.

Growth Medium

The following representative growth medium was used in the examples described below.

TSB (Tryptic Soy Broth)

| | | |
|---|---|---|
| Tryptone | 1.7 | g |
| Soytone | 0.3 | g |
| Dextrose | 0.25 | g |
| Sodium chloride | 0.5 | g |
| Dipotassium phosphate | 0.25 | g |
| DI water | 100 | mL |

| | |
|---|---|
| pH | 7.3 +/− 0.2 |

The solid phase chemicals such as tryptone, soytone, dextrose, sodium chloride and dipotassium phosphate are dissolved in the DI water through boiling, then adjusted to final pH, then about 8 μL aliquots are dispensed into covered 16×150 mm test tubes. The resulting broth is then sterilized through an autoclaving process utilizing steam under pressure with a temperature of no less than about 121° C.+/−1° C. at about 15 psi for about 20 minutes. The cooled broth is then stored at about 5° C.+/−3° C. F to minimize the potential for re-growth of bacteria.

TSA (Tryptic Soy Agar)

| | | |
|---|---|---|
| Tryptone | 7.5 | g |
| Soytone | 2.5 | g |
| Sodium chloride | 2.5 | g |
| Bacto-agar | 7.5 | g |
| DI water | 500 | mL |

| | |
|---|---|
| pH | 7.3 +/− 0.2 |

The solid phase chemicals such as tryptone, soytone, dextrose, sodium chloride and dipotassium phosphate are dissolved in the DI water through boiling, then adjusted to final pH, then sterilized through an autoclaving process utilizing steam under pressure with a temperature of no less than about 121° C.+/−1° C. at about 15 psi for about 20 minutes. Pour tempered media into sterile petri dishes. Store the agar plates at about 5° C.+/−3° C. F to minimize the potential for re-growth of bacteria, until use. Allow plates to warm to room temperature before use.

SLB (Saline Lactose Broth)

| | | |
|---|---|---|
| Sodium chloride | 7.6 | g |
| DI water | 1000 | mL |
| Lactose Broth | 0.39 | g |
| 0.25 M Potassium Phosphate Monobasic | 2 | mL |

Dissolve the solids shown in the table above in the DI water and adjust the pH to about 6.9-7.0 using about 0.1 N sodium hydroxide.

Preparation of Challenge Suspension:

The methods used for preparing the various challenge solutions used in the examples described below and detailed as follows.

Preparation of Challenge Suspension of B. diminuta:

About two days prior to preparing the challenge suspension thaw a cryogenically frozen B. diminuta strain and inoculate one TSB tube with the stock suspension. Incubate at about 30° C.±2° C. for about 24 hours. About Twenty-four hours before the test challenge inoculate appropriate amount of SLB with 1 mL of B. diminuta seed culture per liter of SLB. Incubate at about 30° C.±2° C. for about 24 hours. On the day of preparing challenge suspension, allow TSA plates to warm to room temperature prior to use. Aseptically remove an aliquot of the SLB culture and determine density via optical density or epifluorescence.

Based on the determined density of the SLB culture, prepare a suspension of about 1×10⁸ cfu/L organisms with the General test Water. Remove a 10-mL aliquot from the challenge suspension and set aside for density verification.

Preparation of Challenge Stock MS-2:

All stocks to be grown by a method described by Smith and Gerba (1982, in Methods in Environmental Virology, pp. 15-47) and purified by the procedure of Sharp, et al. (1975, Applied Microbiology, 29:94-101), or similar procedure (Berman and Hoff, 1984, Applied Environmental Microbiology, 48:317-323), as these methods will produce largely monodispersed virion particles, the disclosure of each is herein incorporated by reference to the extent not inconsistent with the present disclosure.

About Two days prior to preparing the challenge suspension thaw a cryogenically frozen E. coli (ATCC #15597) sample and inoculate one TSB tube with the stock suspension. Incubate at about 35° C.±2° C. for about 18 hours without shaking. Inoculate another TSB tube with culture from (a) and incubate for about six (6) hours at about 35° C.±2° C. with shaking to obtain fresh cultures. After these steps, thaw and dilute stock MS-2 and serially dilute in Tris-buffered saline to approximate concentrations of 10⁵ pfu/ml. Add about 0.1 ml of MS-2 phage dilution and 1 ml E. coli culture to tubes of molten overly agar (TSB with about 1% agar) and mix. After mixing, pour mixture into petri dishes containing TSA and incubate for about 18-24 hours at about 35° C.±2° C. Should confluent plaques be observed, add about 6-7 mL Tris buffer to the plates as previously prepared and allow to sit for a maximum of about 1 hour. Recover the liquid fraction and centrifuge (about 15000×g for about 20 minutes at about 10° C.). Recover liquid fraction and filter through a 0.2 micron SterAssure membrane disc (from Cuno Incorporated, Meriden, Conn.) to eliminate bacterial contamination. Recover pellet and resuspend in sterile Tris buffer. Store at about 5° C.±3° C.

Addition of Tris buffer and allowing the plates to remain static for one hour allows the bacteriophage such as MS-2 to diffuse through the agar surface and into the liquid buffer for capture and transfer of the bacteriophage from the agar surface to the test tubes as the concentrated stock solution from which all bacteriophage injections will be made during seeded injections into the test filters.

Preparation of Challenge Suspension of MS-2:

On the day of preparing the challenge suspension, inoculate the appropriate amount of sterile Trizma base (amount to be determined during validation) with an appropriate amount (amount to be determined during validation) of MS-2 seed culture per liter of Tris. Store at about 23° C.±1° C. Allow TSA plates to warm to room temperature (range for room temp) prior to use. Aseptically remove an aliquot of the culture and determine density via optical density or epifluorescence. After these steps, vortex and dilute the cell suspension with the appropriate Test Water to obtain a minimum suspension target of about 1×10⁷ cfu/L. Remove about a 10-mL aliquot from the challenge suspension and set aside for density verification.

Determination of the Concentration of the Challenge Organism

This determination was based upon the unit flow rates, injection feed pump rate, suspension density, and the final challenge organism concentration for the unit challenge. The suspension will have to be of adequate volume to deliver the challenge organism to two complete ON/OFF cycles at each sample point.

For example, for a unit flow rate of about 1.0 gallon per minute (gpm) and a duplicate unit tested so a total of about 2.0 gpm (7,560 mL/min) would be required. When the injection rate is about 10 mL/min and the suspension density is about 1×10⁹/mL, the final concentration would be about 7.0×10⁴/mL. The ON/OFF cycle could be 10 min ON/10 min OFF (20 minutes ON for two complete cycles).

Density Determination of B. diminuta

Make appropriate serial dilutions using sterile SDBW. Plate appropriate (10⁰-10⁻⁵) dilutions in duplicate on TSA plates. Invert and incubate at about 35° C.±0.5° C. for about 48 hours. After incubation, enumerate plates containing about 30-300 distinct colony forming units (cfu) using a Colony Counter. Calculate the density of the B. diminuta suspension by multiplying the number of CFU obtained by the inverse of the dilution factor. Express results as the number of CFU/L.

Density Determination of MS-2

Make serial dilutions (10⁰-10⁻⁴) using sterile SDBW. Plate (10⁰-10⁻⁵) dilutions in duplicate on TSA plates using E. coli as the host organism. Invert and incubate at about 35° C.±0.5° C. for about 48 hours. After incubation, enumerate plates containing 30-300 distinct plaque forming units (pfu) using a Colony Counter. Calculate the density of the MS-2 suspension by multiplying the number of PFU obtained by the inverse of the dilution factor. Express results as the number of PFU/L

Analysis of Negative Control, Influent and Effluent Samples

Negative Control

Plate is heated to about 100° C. of each bacterial strain in duplicate on TSA for B. diminuta. Invert and incubate at about 35° C.±0.5° C. for about 24 hours. Plate 100 the viral strain in triplicate on TSA using E. coli (ATCC #15597) as the host bacteria for the MS-2 bacteriophage. Incubate at about 35° C.±0.5° C. for about 24 hours.

B. diminuta

Influent Samples

Make serial dilutions of the influent samples (10⁰-10⁻⁴) using sterile SDBW. Plate 10⁰-10⁻⁵ dilutions in duplicate on TSA plates. Invert and incubate at about 35° C.±0.5° C. for about 48 hours. After incubation, enumerate plates containing 30-300 distinct colony forming units (CFU) using a Colony Counter. Calculate the influent of the B. diminuta suspension by multiplying the number of CFU obtained by the inverse of the dilution factor. Express results as the number of CFU/L.

Effluent Samples

Aseptically conduct the standard plate count method using a 0.20 micron membrane and plate on TSA. Invert and incubate at about 35° C.±0.5° C. for about 48 hours. If there is no growth present, continue to incubate for up to about 7 days. After incubation, enumerate plates containing about 20-about 200 distinct colony forming units (CFU) using a Colony Counter. Express results as the number of CFU/L.

MS-2

The influent and effluent sample treatments are similar to B. diminuta except that no membrane is used in the effluent samples because plaques are not detectable on the membrane disc; membrane filtration method is not appropriate for plaque count.

Non-pathogenic bacteria commonly found in drinking water systems, also referred to as Heterotrophic Plate Counts (HPC) may interfere with B. diminuta analysis, as B. diminuta is part of the broad classification of organisms contained within the classification ‘HPC’; it is required to eliminate HPC interference to avoid false positive results.

Results

Following incubation, count colonies on all of the influent sample plates. Calculate the mean of colony forming units (cfu) per L for plates with 30-300 colonies or plaque forming units (pfu) per L for plates with 30-300 plaques for viruses. This is the ‘Nₒ’ value.

Following incubation, count colonies on all of the effluent sample plates. Calculate the mean of colony forming units (cfu) per L for plates with 30-300 colonies or plaque forming units (pfu) per L for plates with 30-300 plaques for viruses. This is the ‘Nₛ’ value.

Following incubation, confirm that all effluent bacterial colonies are the test organisms by Gram stain and the biochemical tests specific for B. diminuta. If there are no colonies on the filter(s) corresponding effluent sample(s) plate, then the Log Reduction (LR) for each test filter is approximated using the following formula:
LR˜Log₁₀(Nₒ)

If there are one or more colonies on the effluent sample plate, this filter's LR is calculated from the equation:
LR=Log₁₀(Nₒ/Nₛ)

If the effluent sample plate has confluent growth, the LR cannot be determined and is recorded as such.

### EXAMPLES

A general procedure for the preparation of the representative filter medium blocks used in the examples of the present disclosure is described as follows.

About 28 grams of DE is blended with about 28 grams activated carbon (Barneby & Sutcliffe, Activated Carbon Type 1184), about 16 grams of polyethylene binder (FN510 available from Equistar), about 8 grams of fibrillated polyethylene fiber (UL410 available from Minifiber), about 2 grams of polypropylene unfibrillated fibers (3DPP ¼″ available from Minifiber), about 4 grams of fibrillated polyethylene fibers of smaller size (ESS-5F available from Minifiber), and about 14 grams of Pb reduction media (ATS, from Engelhard) in a uniform manner by a V-shaped blender (Littleford Day, Inc., Polyphase mixers, Model #: FM 130 DX). The components are mixed for about 30 seconds, then mixed and chopped for about 10 minutes. The blended mixture, called “flock”, is fed into a standard 6″ block mold via the shaking table, vibration chute and vacuum line, as would be understood by one skilled in the art. The mold is compressed (Conoflow, ITT Fluid Tech Corporation, Loomis Hydraulic Press) isopiestically to about 750 psi at about room temperature to obtain the green strength. After the compression operation, the resultant is known as a “block”. The block is then oven (Lunair Limited, Gruenberg Oven, Model #: C35V31.50M) baked at about 60° C. for about 1-hour, then at about 114° C. for about 40-minutes. The block then undergoes subsequent OD (outer dimension) lathing on the Central Machinery Bench Lathe to obtain an average OD of about 1.5″. Each lathed block is subsequently cut on the Rigid Saw to a length of about 6″.

Impregnation of Silver Species onto DE.

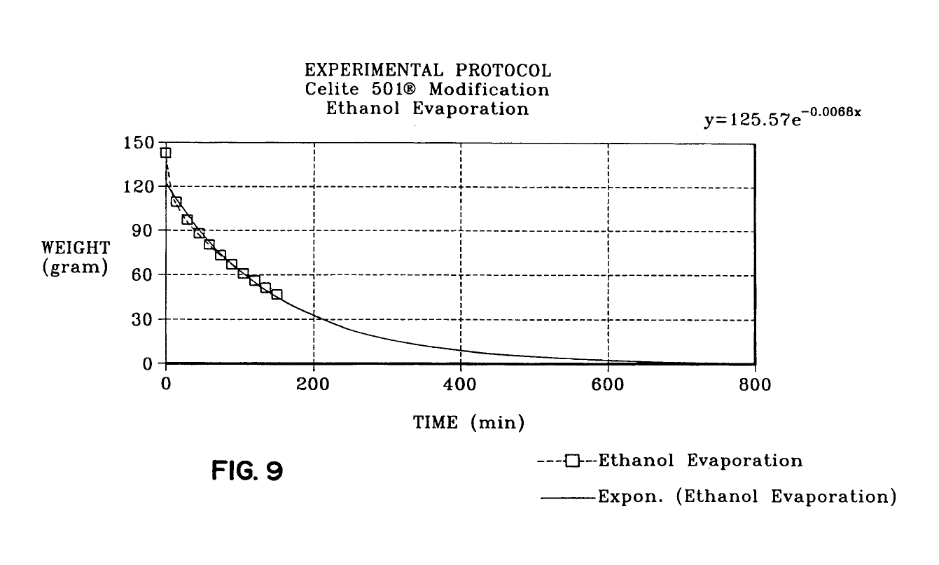

The procedure used to impregnate the silver species into DE was as follows. The silver nitrate (available from J. T. Baker), 1.6 grams, was added to 1 liter ethanol and stirred until complete dissolution. The solution was added to 1 kg DE (Celite® 501 available from World Minerals) in a 2-liter container in a dropwise manner until incipient wetness stage was reached, while continually stirring the mixture. The impregnated Celite® 501 was transferred to a shallow tray and spread evenly so that the powder depth is about half inch. The tray with the content was rested in a fume hood, with occasional agitating the Celite® 501 powder, for a period of about 15 hours or longer until no detectable ethanol evaporation, as evidenced in FIG. 9.

The contents of the tray were then transferred to a muffle furnace (Lindberg Blue M oven Model #: MO1440A-1) and then heated at about 440° C. for about 30 minutes. After cooling to room temperature, the impregnated Celite® 501 is ready for further treatment.

Modification of DE Surface with Octadecylaminodimethyl Trimethoxysilylpropyl Ammonium Chloride.

The modification of the surface of DE with octadecylaminodimethyl trimethoxysilylpropyl ammonium chloride was accomplished as follows. One hundred g of DE (Celite® 501 available from World Minerals) was weighed out into a glass beaker and a 110 g water solution of 2 g octadecylaminodimethyl trimethoxysilylpropyl ammonium chloride (available from Dow Corning Corporation as DC9-6346) was slowly (about 1 gram per minute) added while the beaker was subject to slow tumbling (about 2 revolutions per second) to reach a uniform mixing and distribution of added liquid to the solid DE powders. After finishing the addition, the content was transferred to a tray and was placed in an about 80° C. oven for about four hours and then about 120° C. for about four hours. Longer time treatment didn't seem to affect the results. The DE was rinsed 4 times with 1 L DI water in a screw-top jar and tumbled on a roller mill to ensure uniform wetting and rinsing, then the content was vacuum filtered through a Whatman paper before being placed in a about 120° C. oven for about 4 hours or until the treated DE was fully dried.

The following tests demonstrate the presence of a representative modifying agent on the surface of Celite 501, even after very extensive washing of this DE, by using the example of DC9-6346 as the modifying agent.

Fourier Transform Infra-Red (FTIR) Spectroscopy

FTIR spectra of untreated and DC9-6346 treated DE are shown below:

[image]

The top and the middle spectra show the untreated Celite 501 and the DC9-6346 treated Celite 501. Both spectra show strong Si—O bands at about 1070 & 790 cm⁻¹ as well as smaller bands at about 1990, about 1870, & about 1620 cm⁻¹. The spectra of the silane treated Celite 501 also displays aliphatic bands at about 2920 & about 2850 cm⁻¹ not present in the untreated Celite 501 spectrum.

The bottom spectrum is DC9-6346. The absorption bands at about 2920 & about 2850 cm⁻¹ seen in the treated Celite 501 spectrum (but not in the untreated Celite 501 spectrum) match up well with similar bands in the spectrum of DC9-6346.

An absorption band at about 1460 cm⁻¹ in the spectrum of the DC9-6346 treated Celite 501 (but not in the untreated Celite 501 spectrum) is close, but not an exact match, to a band at about 1470 cm⁻¹ in the spectrum of the DC9-6346.

Zeta Potential

Zeta potential of this study was conducted with Electro Kinetic Analyzer (EKA) from Anton Paar. For the untreated and DC9-6346 treated Celite 501, the difference is that the treated DE possesses positive charge even when the pH is as high as about 10. The untreated DE has a negative zeta potential in the pH range of about 5.5 to about 10.5.

[image]

Each DC9-6346 treated DE has been washed extensively to remove any free silane molecules. One such washing method is to wash about 50 grams of treated DE with about 0.8 liters of water followed by about 0.2 liters of a water rinse after filtration. The table below shows that after 5 sequential washes, the silane concentration is below the limit of quantitation (<0.40 mg/L).

| Sample ID | Nitrogen (mg/L) |
|---|---|
| 1st liter rinse | 4.3 |
| 2nd liter rinse | 3.2 |
| 3rd liter rinse | 0.63 |
| 4th liter rinse | 0.56 |
| 5th liter rinse | <0.40 |
| 6th liter rinse | <0.40 |
| 7th liter rinse | <0.40 |
| DI water control | N.D. |

Modification of DE with a Linker and Solfix E.

The modification of the surface of DE with a linker and Solfix E was accomplished as follows. One hundred g of DE (Celite® 501 available from World Minerals) was weighed out into a glass beaker and about 110 g water solution of about 1.2 g 3-aminopropyltriethoxysilane (available from Gelest, Inc.) was slowly (about 1 gram per minute) added while the beaker was subject to slow tumbling (about 2 revolutions per second) to reach a uniform mixing and distribution of added liquid to the solid DE powders. After finishing the addition, the content was transferred to a tray and was placed in an about 115° C. oven for about four hours. Longer time treatment didn't seem to affect the results. The treated DE was rinsed 4 times with about 1 L DI water in a screw-top jar and tumbled on a roller mill to ensure uniform wetting and rinsing, then the content was vacuum filtered through a Whatman paper before being placed in an about 115° C. oven for about 4 hours or until the treated DE was fully dried. A caustic Solfix E (available as 20% concentration from Ciba Specialty Chemicals, Inc.) solution was prepared by dissolving about 33.75 g 20% Solfix E and about 33.75 g 5N NaOH into about 575 g DI water and mixed well. The resulted Solfix E solution was added to the previously treated DE in a similar manner. After washing, the content was transferred to a tray and dried as before.

It is believed that a range of anionic counter ion to the catatonically modified DE may be used, where an anion is defined as an atom or a group of atoms that possess a net negative charge.

Once the preparatory work described above that is required to conduct the experiments was completed, the feasibility of the new and innovative filter media was tested. The procedures followed during the conduct of these experiments are discussed below in Examples 1-3.

### Example 1

### Antimicrobial Reduction Test with Unmodified Filter Media

A representative filter block that was composed of about 28% AC, about 28% unmodified DE, about 16% polyethylene binder FN510, about 8% polyethylene fiber UL410, about 2% polypropylene fiber 3DPP ¼″, about 4% polyethylene ESS-5F, and about 14% ATS. The block was fitted into a filter housing with a fluid inlet and a fluid outlet to constitute a filter device similar to those filter devices used in water filtration applications.

The filter device was then tested as per the USEPA Guide Standard and Test Protocol (1987), the disclosure of which is hereby incorporated by reference.

The 20 gallon challenge test water made with unfiltered tap water was refrigerated overnight. Residual chlorine was left in the tank to inhibit bacterial growth during the overnight cool down. The general test water was made with tap water filtered by an Aqua Pure™ AP117 chlorine reduction filter available from Cuno, Inc. Both tanks were tested for total chlorine by a Hach™ DR/700 Colorimeter with the AccuVac™ DPD Total Chlorine Reagent. If the total chlorine was greater or equal to about 0.02 mg/L, about 3% sodium thiosulfate solution (w/v) was added to each tank (about 0.1 mL of about 3% sodium thiosulfate per about 1200 mL of water). After the agitation, the tanks were then resampled and retested for total chlorine. Sodium thiosulfate was added, as stated above, until the total chlorine was below about 0.02 mg/L.

During the course of the test, MS-2 (ATCC 15597-B1) was used to seed the general test water tank to a concentration of about 10⁶ PFU/mL, and Klebsiella terrigena (ATCC-33257) was used to seed the water tank to a concentration of about 10⁸/l. (The following table shows the result of this example:

| | Influent concentration | Effluent concentration | Log reduction |
|---|---|---|---|
| Time | (pfu/l) | (pfu/l) | value |
| Day 1 | 1.0E+07 | 1.04E+05 | 2.0 |
| Day 3 | 1.45E+07 | 7.35E+05 | 1.3 |
| Day 6 | 1.44E+07 | 1.22E+06 | 1.1 |

As can be seen from the results, the influent challenge of the bacteriophages has been maintained in the specified concentrations of approximately 1.0E+07 pfu/l; this is referred to as the ‘Nₒ’ value. The effluent concentration, or the concentration of the bacteriophage MS2 detected in the water exiting the filter, is shown to be between 1.5E+05 pfu/l and 1.22E+06 per l; these would be referred to as the ‘Nₛ’ values. As described previously in this disclosure the log of the ratio of the influent concentration Nₒ to the effluent concentration Nₛ is the Log Reduction Value (also referred to as the ‘LRV’) as shown in the above table; this is the direct measure of the viral reduction capability of the filter. According to the calculation detailed earlier in this disclosure, there was a reduction of from about 1 to about 2 log of the bacteriophage MS-2 in the general test water environment utilizing just the filter block alone without any modifications thereto. This is insufficient to address the viral reduction requirements as prescribed by the EPA Protocol, as one point in the test was two orders of magnitude below the minimum four-log viral reduction requirement.

### Example 2

### Antimicrobial Reduction Test with Modified Filter Media

A filter block that was composed of the same ingredients as used in Example 1 except that DE was modified based on the methods described above. The results are illustrated utilizing the bacteriophage MS-2 as the test organism seeded into the general test water environment in the following table:

| | Influent concentration | Effluent concentration | Log reduction |
|---|---|---|---|
| Time | (pfu/l) | (pfu/l) | value |
| Day 1 | 1.00E+07 | 1.0E+02 | 5 |
| Day 3 | 1.45E+07 | <1.0E+02 | >5 |
| Day 6 | 1.44E+07 | <1.0E+02 | >5 |

As can be seen from the results, the influent challenge of the bacteriophages into the filtration system has been maintained in the specified concentrations of approximately 1.0E+07 pfu/l; this is referred to as the ‘Nₒ’ value. The effluent concentration, or the concentration of the bacteriophage MS2 detected in the water exiting the filter, is shown to be non detectable (less than about 100 pfu/l, which is the limit of detection using this protocol), up to about 100 pfu/l; these would be referred to as the ‘Nₛ’ values. As described previously in this disclosure, since the effluent MS-2 level is too low to be adequately quantified by this method, the log of the influent concentration Nₒ can be approximated as the Log Reduction Value (also referred to as the ‘LRV’) as shown in the above table; this is the direct measure of the viral reduction capability of the filter. According to the calculation detailed earlier in this disclosure, there was a reduction of greater than four logs of the bacteriophage MS-2 in the seeded general test water environment utilizing just the modified filter block. The modifications in the filter block as described in this disclosure have generated a significantly greater viral reduction when compared to an unmodified block.

### Example 3

### Antimicrobial Reduction Test with Modified Filter Media Wrapped with a 0.2% Nylon Membrane

A filter block that was composed of the same ingredients as used in Example 2 except that a pleated 0.2μ nylon membrane was used to wrap around the filter block. The test results are shown in the following table:

| | Influent concentration | Effluent concentration | Log reduction |
|---|---|---|---|
| Time | (pfu/l) | (pfu/l) | value |
| Day 1 | 1.00E+07 | 1.00E+02 | 5 |
| Day 3 | 1.45E+07 | 4.00E+02 | 4.6 |
| Day 6 | 1.44E+07 | <1.00E+02 | >5 |

As can be seen from the results, the influent challenge of the bacteriophages into the filtration system has been maintained in the specified concentrations of approximately 1.0E+07 pfu/l; this is referred to as the ‘Nₒ’ value. The effluent concentration, or the concentration of the bacteriophage MS2 detected in the water exiting the filter, is shown to be non detectable (less than about 10 pfu/l, which is the limit of detection using this protocol); these would be referred to as the ‘Nₛ’ values. As described previously in this disclosure, when the effluent MS-2 level is too low to be adequately quantified by this method, the log of the influent concentration Nₒ can be approximated as the Log Reduction Value (also referred to as the ‘LRV’) as shown in the above table; this is the direct measure of the viral reduction capability of the filter. According to the calculation detailed earlier in this disclosure, there was a reduction of greater than four logs of the bacteriophage MS-2 in the seeded general test water environment utilizing just the modified filter block. The modifications in the filter block as described in this disclosure have generated a significantly greater viral reduction when compared to an unmodified block.

It is further believed that the use of a the use of a pre-filtration membrane stage having a porosity smaller, equal, or slightly greater than the porosity of the carbon block (with or without modifications) can mechanically remove a significant fraction of the colloidal contamination such as test dust and certain types of sparingly soluble humic acids, reduce the contaminant load on the fine pore structures of the carbon block, and generate an overall increase in the available surface area of the carbon block towards viral reduction.

As should be clear to those skilled in the art from the above, the modifications of the representative filter block as described in the present disclosure result in significant reduction of microbes from the representative fluid, water. As would most likely be understood by one skilled in the art, similar results would most likely be expected in removing microbes from gases, such as, for example air. While specific experiments designed to verify removal of microbes from gas such as air have not yet been completed, it is anticipated that microbial reduction achieved utilizing the principals described above would be proven.

While the articles, apparatus and methods for making the articles contained herein constitute preferred embodiments of the disclosure, it is to be understood that the disclosure is not limited to these precise articles, apparatus and methods, and that changes may be made therein without departing from the scope of the disclosure which is defined in the appended claims.

What is claimed is:

1. A separation media comprising:
a base mixture having an adsorptive organic component and a surface-modified inorganic component, the surface-modified inorganic component being a reaction product of an anti-microbial component comprising a quaternary ammonium salt containing an epoxide group and an inorganic component, and thereby comprising a covalent bond directly between the quaternary ammonium cation and the inorganic component.

2. The separation media of claim 1, wherein the covalent bond is the result of a reaction between the epoxide group and a hydroxyl group of the inorganic component.

3. The separation media of claim 1, wherein the quaternary ammonium salt containing the epoxide group is poly(methyldiallylamine epichlorohydrin).

4. The separation media of claim 1, wherein the quaternary ammonium salt containing the epoxide group has the formula according to I: 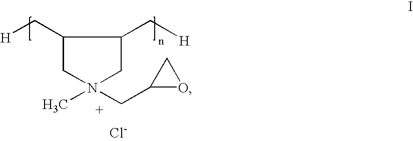
wherein n is in the range of 5 to 24.

5. The separation media of claim 1, wherein the inorganic component comprises diatomaceous earth.

6. The separation media of claim 1, wherein the adsorptive organic component comprises activated carbon.

7. The separation media of claim 1, wherein the surface-modified inorganic component has a positive zeta potential at pH in the range of about 5 to about 9.

8. The separation media of claim 1, which is free of a coupling agent.

9. A separation media comprising: activated carbon, and a reaction product of diatomaceous earth and a quaternary ammonium salt containing an epoxide group having the formula according to I: 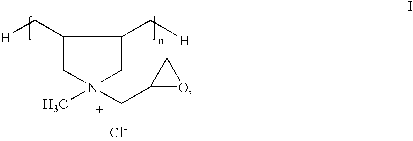
wherein n is in the range of 5 to 24; and
the reaction product comprising a covalent bond directly between the quaternary ammonium cation and the inorganic component.

10. The separation media of claim 9, wherein the covalent bond is the result of a reaction between the epoxide group and a hydroxyl group of the inorganic component.

11. The separation media of claim 9, wherein the reaction product has a positive zeta potential at pH in the range of about 5 to about 9.

12. The separation media of claim 1, wherein the anti-microbial component is substantially free of transition metals.

13. The separation media of claim 12, wherein the anti-microbial component is substantially free of silver.

14. An antimicrobial separation media consisting essentially of:
an adsorptive organic component and a reaction product of an anti-microbial component and an inorganic compound, wherein the anti-microbial component comprises a quaternary ammonium salt containing an epoxide group and the reaction product comprises a covalent bond directly between the quaternary ammonium cation and the inorganic compound.

15. The separation media of claim 14, wherein the covalent bond is the result of a reaction between the epoxide group and a hydroxyl group of the inorganic component.

16. The separation media of claim 14, wherein the quaternary ammonium salt containing the epoxide group has the formula according to I: 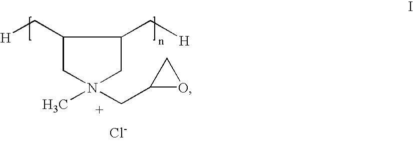
wherein n is in the range of 5 to 24.

17. The separation media of claim 14, wherein the inorganic component comprises diatomaceous earth.

18. The separation media of claim 14, wherein the adsorptive organic component comprises activated carbon.

19. The separation media of claim 14, wherein the quaternary ammonium salt containing the epoxide group is poly(methyldiallylamine epichlorohydrin).

20. A method of water filtration comprising: providing a base mixture having an adsorptive organic component and a surface-modified inorganic component, the surface-modified inorganic component being a reaction product of an anti-microbial component comprising a quaternary ammonium salt containing an epoxide group and an inorganic component, and thereby comprising a covalent bond directly between the quaternary ammonium cation and the inorganic component to form a separation media; and contacting the separation media with water.
